(19) United States
(12) Patent Application Publication
(10) Pub. No.: US 2022/0297026 A1
(43) Pub. Date: Sep. 22, 2022

(54) CLOG FREE CONDENSATION SYSTEM FOR PYROLYSIS VAPOR OF PET CONTAINING POLYMER

(71) Applicant: Suhas Dixit, Navi Mumbai (IN)

(72) Inventor: Suhas Dixit, Navi Mumbai (IN)

(21) Appl. No.: 17/618,460

(22) PCT Filed: Jun. 12, 2020
(86) PCT No.: PCT/IN2020/050523

§ 371 Date: Dec. 11, 2021

(30) Foreign Application Priority Data
Jun. 12, 2019 (IN) 201921023312

(51) Int. Cl. B01D 5/00; C08J 11/08; C10G 1/10; B01D 17/04

(52) U.S. Cl. CPC B01D 5/009; C08J 11/08; C10G 1/10; B01D 5/0027; B01D 17/047; C08J 2367/02; C10G 2300/1003

(57) ABSTRACT

The invention provides a clog-free condensation system for a pyrolysis apparatus used in the thermal degradation of waste plastics that contain polyethylene terephthalate (PET). A conduit carries vapor from a pyrolysis reactor to a condenser having an inlet for an oil-immiscible solvent stream; a liquid outlet for removal of the oil-immiscible solvent, benzoic acid, and other condensed pyrolysates; and a vapor outlet to pass uncondensed vapors. A liquid-liquid phase separator connected to the liquid outlet continuously separates the two immiscible phases. Benzoic acid is precipitated and removed from the oil-immiscible phase, and the oil-immiscible solvent is returned to the condenser as a solvent stream. The invention provides a method for condensing PET pyrolysis vapors without formation of clogs in the condensation apparatus, and provides a method for the continuous recovery of benzoic acid and other condensable pyrolysates from a PET-containing waste plastic stream.

### FIELD OF INVENTION

The present invention relates to a clog-free condensation system for pyrolysis vapour of Polyethylene terephthalate (PET) containing polymer that provides an efficient pyrolysis of feedstock containing Polyethylene terephthalate (PET) polymer. More specifically, the present invention provides an improved condensation system for preventing clogging of pyrolysis apparatus and smooth running of thermal degradation waste plastic comprising PET containing polymer. The present invention also relates to a method for pyrolysis of PET mixed plastic waste without formation of clog in apparatus and continuous recovery of Benzoic-acid and other condensable hydrocarbons as a value added products.

### BACKGROUND OF THE INVENTION

Plastic resin like Polyethylene terephthalate (PET or PETE) is a popular choice for packaging and part of multilayer packaging (MLP). PET is inexpensive, lightweight, resealable, shatter-resistant and recyclable and hence frequently employed to package a range of products including beverages, bakery goods, food produce, frozen foods, cosmetics, and household cleaners.

It has been long recognised that plastic waste generated by human society need to be completely recycled or reclaimed to stop the growing threat to the environment. Potential techniques for PET recycling include different methods of hydrolysis, glycolysis and methanolysis to produce depolymerised product i.e. monomers of PET. However, these processes demand pure PET waste and intensive cleaning steps even when only PET based plastic needs to process as pyrolysis system never works if Polyethylene terephthalate (PET) is present in the feedstock which results in clogging of the condenser, receiver, and internal piping used for condensing the post pyrolysis stream.

Further, maintaining the purity of the flakes (waste PET flakes) is important for preserving the reclaimed plastic's value, as non-reusable elements can reduce workability and, ultimately, profitability.

Moreover, used containers as received at the recycling plant ordinarily include PET bottles, aluminium caps and contaminants such as paper labels, adhesives holding the labels. To provide salable recycled products, the other polymers (polyolefin) and PET components are separated from one another. There are numerous techniques disclosed in the literature providing PET plastic reclamation procedures involving separation/sorting of different types of resin based on different density level or by chemical treatment in order to separate PET from non-usable elements.

Like, in U.S. Pat. No. 5,554,657A, it is discloses a Process for recycling mixed polymer containing polyethylene terephthalate involving steps of steps of: (1) contacting the mixed polymer recycle stream with a solvent which selectively dissolves the PET. (2) separating the selective solvent containing PET from the residual mixed polymer, (3) cooling the selective solvent to precipitate the PET, and (4) removing the selective solvent from the precipitated PET. The PET recovered is preferably combined with “virgin” PET and further processed to increase its molecular weight.

U.S. Pat. No. 4,830,188A discloses plastics separation and recycling methods wherein mixed flakes are placed into a flotation liquid so that each flake sinks or floats according to its density by maintaining the effective level of surfactant in the flotation liquid. Those flakes denser than the flotation liquid tend to sink, whereas those flakes less dense than the flotation liquid will tend to float. Each separated resin product is suitable for normal processing by conventional plastic molding and extrusion techniques.

Now a days Polymer-based multilayer packaging materials are commonly used in order to combine the respective performance of different polymers i.e. combination of polyethylene terephthalate (PET), polystyrene (PS), polyethylene (PE), polypropylene (PP), polyvinyl chloride (PC), acrylonitrile butadiene styrene (ABS), poly(methyl methacrylate) (PMMA), nylon, metallised PET etc. However, because of their poor recyclability due to difficulties in separation of individual resins, most multilayers are usually incinerated or landfilled.

Pyrolysis is considered as a promising option for multilayer packaging recycling against mechanical recycling (depolymerisation) due to complexity of the packaging systems (combination of two or more resins).

U.S. Pat. No. 5,753,086A, discloses an apparatus for pyrolysis (thermal decomposition 350 to 700° C.) waste plastic in a diluent such as hot oil, acid and gases. In particular municipal, health and industrial waste plastics are processed such as (but not limited to) polyethylene (PE), polypropylene (PP), polystyrene (PS), polyethylene terephthalate (PET), polyurethane (PU), and polyvinyl chloride (PVC).

The major issue addressed by above pyrolysis technique for mixed resin waste plastic is when the feedstock contains PET material due to its by-product Benzoic-acid. Therefore, PET was not employed in experiment since its solid decomposition product tended to clog the apparatus because of deposition of sticky mass in internal wall of condenser, piping and receiver inlets. Which is forwardly terminated the pyrolyzing feedstock containing PET polymer. And leaving only way to incinerate or throw in landfill. The clogging of condenser is because of solidifying (sublimation) of one of the pyrolysis by-product of PET i.e. Benzoic-acid.

Hence, the present invention has been made in consideration of the above-described pyrolysis apparatus clogging problem, and an objective thereof is to provide a system and method for preventing the sublimation of Benzoic-acid in condenser pipe and thereby preventing the clogging of pyrolysis apparatus when PET containing mixed plastic has been utilised as a feedstock.

Accordingly, with the advent of more carefully design and configuration of condenser in post pyrolysis system, the clog formation is prevented and thereby feedstock containing PET polymer can be successfully pyrolyzed back into its oil/hydrocarbon components.

### SUMMARY OF THE INVENTION

One of the objectives of the present invention is to provide a condensation system with clog removal functionality useful in pyrolysis of PET containing plastics and method thereof.

Second objective of the present invention is to provide the pyrolysis system suitable for conducting pyrolysis of feedstock containing PET polymer.

Another objective of the present invention is to provide the method of condensation for isolation of Benzoic-acid from hydrocarbon condensable materials from PET containing plastics.

Yet, one more objective of the present invention is to prevent the incineration or landfill of polymers such as PET containing plastic waste to safeguard an environment.

Therefore, the present invention has been made in order to solve the above-described problems at once, and a main object thereof is to make it possible to continuously run the pyrolysis reactor when Polyethylene terephthalate (PET) is contained in feedstock without making a system to stop to clean the condensers.

That is, a pyrolysis reaction vapour condensation system according to the present invention is one suitable for clog-free pyrolysis of polymer such as Polyethylene terephthalate (PET) in pyrolysis feedstock that produces a vapour of pyrolysis oil and by-products including Benzoic-acid and its derivatives (Sodium benzoate etc), the system comprising of condenser for condensing a pyrolysis reaction vapour with direct stream of oil-immiscible solvent at an initial step followed by liquid-liquid separator for separating a phases of the said condensed stream, the said system further characterized in precipitating out a by-product of pyrolysis reaction and recirculating at least a part of oil immiscible solvent stream into the condenser at the initial step. The present invention also provides a method to operate the said system in detail.

As a specific embodiment, the present invention provides an improved clog-free condensation system for pyrolysis vapour to enable continuous pyrolysis reaction of polymer having fraction of Polyethylene terephthalate (PET) comprises of:
a. a conduit (2) carrying vapor stream received from pyrolysis reactor (1),
b. a condenser (3) with inlet (4) for oil-immiscible solvent stream and liquid outlet (5) for stripping of condensed pyrolysis oil as well as Benzoic-acid and its derivatives dissolved in oil-immiscible solvent and vapour outlet (6) to pass uncondensed vapours,
c. Liquid-liquid phase separator (7) connected to outlet (5) of condenser (3) and having outlets (8 and 9) for separating two immiscible phases;

Characterized in that, the vapour stream coming in condenser (3) is humidified with stream of oil-immiscible solvent to obtain a liquid stream containing a mixture of pyrolysis oil with oil-immiscible solvent rich in Benzoic-acid and its derivatives before it solidifies into sticky powder and thereby avoiding a clog formation.

It is preferable that the condensation system as per present invention includes a precipitating part for by-product to obtained in a pure powder form, wherein outlet (9) of phase separator is configured with precipitating bath (10) to precipitate out Benzoic-acid and its derivatives from oil-immiscible solvent. The outlet of precipitating bath (10) is configured with solid-liquid separator (11) to obtain a powder of Benzoic-acid and its derivatives at outlet (12) and liquid stream of oil-immiscible solvent at outlet (13).

In yet another embodiment, liquid-liquid phase separator (7) is positioned with parallelly placed second liquid-liquid phase separator (7′) having outlets (8′ and 9′) using flow diversion valve (22) to increase residence time of phase separation.

Such configuration makes it possible to recover the pyrolysis by-products into a pure saleable compound.

Accordingly, in an embodiment the precipitating bath (10) is selected from the temperature controlled bath and bath having provision of supplying solution to the bath.

Accordingly, in an embodiment the solid-liquid separator (11) is selected from Filter press, centrifuge, nutche filter, agitated nutche filter, pressure leaf filter, gravity filter and vacuum filtration system.

In order to ensure the reuse of oil-immiscible solvent required for initial step condenser, the filtrate outlet of solid-liquid separator (11) is connected to inlet (4) of condenser (3) through a pump (14) and heat exchanger (15).

In yet another embodiment, the present invention relates to an improved condensation system wherein the condenser (3) is configured with additional condensers (16, 19) in series. Characterized in that condenser in series are selected and not limiting from shell and tube condenser, central flow condenser, down flow condenser, inverted flow condenser and evaporative condenser, Jet condenser, direct contact condenser or combination thereof.

### BRIEF DESCRIPTION OF DRAWINGS

For a more complete understanding of the features and advantages of the present invention, reference is now made to the detailed description of the invention along with the accompanying figures and in which:

FIG. 1: a schematic diagram illustrating the configuration of condensation system for clog-free pyrolysis of pet in the present embodiment.

FIG. 2: a schematic diagram illustrating the configuration of a precipitation bath and recirculation of oil-immiscible solvent stream in the present embodiment.

FIG. 3: a schematic diagram illustrating the configuration of a two liquid-liquid separators in the present embodiment.

FIG. 4: a schematic diagram illustrating the configuration of sequential condensers in the present embodiment.

### DETAILED DESCRIPTION OF THE INVENTION

The following describes the technical solutions in the embodiments of the present application with reference to the accompanying drawings in the embodiments of the present application as pyrolysis system never works if Polyethylene terephthalate (PET) is present in the feedstock which results in clogging of the condenser, receiver, and internal piping used for condensing the post pyrolysis stream.

It should be understood that the accompanying drawings are merely intended to explain the present subject matter, wherein component sizes, proportional relations and component quantities are not restrictions on the present subject matter.

The present subject matter relates to an improved condensation system for clog-free pyrolysis of PET containing mixed plastic waste. After pyrolysis in a pyrolysis reactor, pyrolysis vapours/gas is discharged through a pipeline. The fundamental pyrolysis reaction is very complex and provides several products in vapour; the main components of the pyrolysis gas are oils like different hydrocarbons, methane, hydrogen, carbon monoxide and carbon dioxide and different by-products depending on feedstock. The pyrolysis gas enters a condenser for condensation.

However, when Benzoic-acid and its derivatives are present in pyrolysis vapour when PET is part of pyrolysis feedstock, the conventional condensation systems will solidify the Benzoic-acid and its derivative in sticky mass, so it accumulates in the condenser outlet. This ultimately results in excessively high back-pressure in the condensers, increased risk of leakage, and damage to the condenser during long term operation.

In conventional pyrolysis plant, specifically Benzoic-acid is one of the product of pyrolysis of PET, which is coming mixed as vapor and when condensed in conventional pyrolysis system at temperature about 30 to 250° C., forms a sticky mass due to having low solubility at low temperature. Boiling point of Benzoic-acid is about 250° C. and melting point is about 122° C. In addition to that the solubility of Benzoic-acid in water is also temperature dependent i.e. at 40° C. solubility is about 5 g/L, at 75° C. solubility is about 21 g/L and 100° C. solubility is about 56 g/L. Therefore, when vapour of pyrolysis of PET are condensed at below 200° C., it forms a sticky mass and adhere to internal lining of apparatus, which lead to clogging of entire pyrolysis system.

Therefore, the present invention has been made in order to solve the above-described problems at once, and a main object thereof is to make it possible to continuously run the pyrolysis reactor when Polyethylene terephthalate (PET) is contained in feedstock without making a system to stop to clean the condensers. The novel and improved condenser system installation in pyrolysis of PET containing mixed plastic feedstock is effectively avoids the clogging of pyrolysis plant.

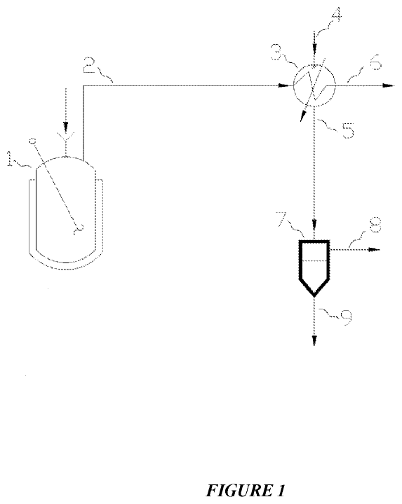

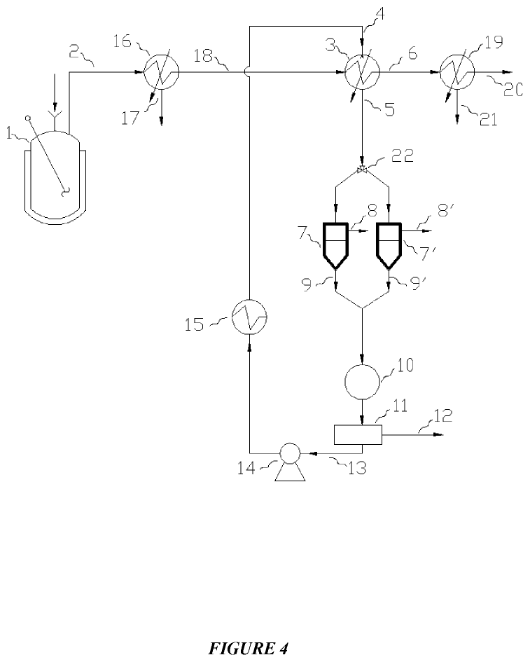

Referring now to accompanying FIGS. 1 and 4 of the drawing, a system in accordance with the teachings of the invention is schematically illustrated. A pyrolysis reactor (1) is provided which may be of conventional shape and of any suitable material.

As a specific embodiment and referring to FIG. 1, the present invention provides an improved clog-free condensation system to enable continuous pyrolysis reaction of polymer having fraction of Polyethylene terephthalate (PET) comprises of:
a conduit (2) carrying vapor stream received from pyrolysis reactor (1),
a condenser (3) with inlet (4) for oil-immiscible solvent stream and liquid outlet (5) for stripping of condensed pyrolysis oil as well as Benzoic-acid and its derivatives dissolved in oil-immiscible solvent and vapour outlet (6) to pass uncondensed vapours,
Liquid-liquid phase separator (7) connected to outlet (5) of condenser (3) and having outlets (8 and 9) for separating two immiscible phases;
   Characterized in that, the vapour stream coming in condenser (3) is humidified with stream of oil-immiscible solvent to obtain a liquid stream containing a mixture of pyrolysis oil with oil-immiscible solvent rich in Benzoic-acid and its derivatives before it solidifies into sticky powder and thereby avoiding a clog formation.

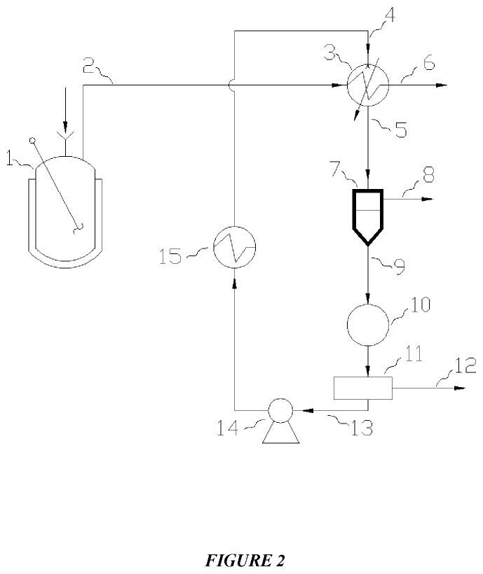

Referring to FIG. 2, it is preferable that the condensation system as per present invention includes a precipitating part for by-product to obtained in a pure powder form, wherein outlet (9) of phase separator is configured with precipitating bath (10) to precipitate out Benzoic-acid and its derivatives from oil-immiscible solvent. The outlet of precipitating bath (10) is configured with solid-liquid separator (11) to obtain a powder of Benzoic-acid and its derivatives at outlet (12) and liquid stream of oil-immiscible solvent at outlet (13). Such configuration makes it possible to recover the pyrolysis by-products into a pure saleable compound.

Further, in order to ensure the reuse of oil-immiscible solvent required for initial step condenser, the filtrate outlet of solid-liquid separator (11) is connected to inlet (4) of condenser (3) through a pump (14) and heat exchanger (15).

Accordingly, in an embodiment the precipitating bath (10) is selected from the temperature controlled bath and bath having provision of supplying solution to the bath.

Accordingly, in an embodiment the solid-liquid separator (11) is selected from Filter press, centrifuge, nutche filter, agitated nutche filter, pressure leaf filter, gravity filter and vacuum filtration system.

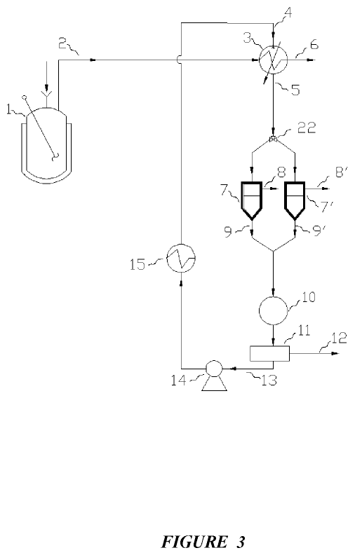

Referring to FIG. 3 and in yet another embodiment, liquid-liquid phase separator (7) is positioned with parallelly placed second liquid-liquid phase separator (7′) having outlets (8′ and 9′) using flow diversion valve (22) to increase residence time of phase separation.

Referring to FIG. 4 and in yet another embodiment, the present invention relates to an improved condensation system wherein the condenser (3) is configured with additional condensers (16, 19) in series. Characterized in that condenser in series are selected and not limited to shell and tube condenser, central flow condenser, down flow condenser, inverted flow condenser and evaporative condenser, Jet condenser, direct contact condenser or combination thereof.

In yet another embodiment, the present invention also provides a method to operate the system as disclosed in FIGS. 1-3.

During operation, the method to operate system is comprising of condensation of pyrolysis vapour coming from pyrolysis reactor (1) through a conduit (2) comprising contacting a fraction of Benzoic-acid and it's derivative with direct contact of oil-immiscible solvent stream received from inlet (4) with vapour stream in the condenser (3) at predetermined temperature, the pyrolysis oil and the Benzoic-acid and its derivative mix in oil-immiscible solvent such as water, alkaline water (pH 7-14), and then enter the outlet pipe (5) and passing uncondensed vapours at outlet (6). A liquid-liquid phase separator (7) is disposed of at this outlet.

Moreover, the liquid-liquid phase separator (7) is preferably arranged to two liquid phases (one phase is oil-immiscible solvent rich in dissolved Benzoic-acid and its derivative and second phase of pyrolysis oil), so that a stripping of Benzoic-acid along oil-immiscible solvent with an temperature and pH action due to the solubility of Benzoic-acid in oil-immiscible solvent causes the Benzoic-acid to stripping from the condensation region, reducing the interference caused to the vapour flow in said condenser.

A portion of oil-immiscible solvent rich in dissolved Benzoic-acid and its derivative is separated out from pyrolysis oil that may be the main value added product of pyrolysis. In this implementation, the second liquid-liquid phase separator (7′) is placed parallel thereon to provide good residence time for phase separation like one or more Hr standby for each separator with the help of flow diversion of outlet (5) collection at valve (22).

During precipitation operation, oil-immiscible solvent rich in dissolved Benzoic-acid and its derivative enters from the outlet (9) to a precipitation bath (10), and forms a precipitate of Benzoic-acid and derivatives due to the presence of acid like hydrochloric acid/sulphuric acid (between pH 0.001 to 7) or temperature is reduced below solubility point of Benzoic-acid in said oil-immiscible solvent. The said suspension then passes through a solid-liquid separator to separate the crystals of Benzoic-acid and its derivative at outlet (12). The filtrate Oil-immiscible solvent collected at outlet (13) can be recirculated to condenser (3) via a heat exchanger (15) using pump (14).

Wherein, referring to FIG. 4 and as per present invention teaching, a multi-condenser (16, 3 and 19) configured in sequential manner are provided with aim to separate different condensable component of pyrolysis reaction coming out of pyrolysis reactor (1) in gaseous form and said approximate condensable are provided below:
a) at First condenser (16): Condensates waxes (particularly hydrocarbons comprising mixture of maximum between C25 and above) at outlet (17) and pass the uncondensed vapour through conduit (18),
b) at Middle Main condenser (3): Condensates mixture of hydrocarbons comprising maximum between C10-C25 and Benzoic-acid and its derivatives leaving uncondensed vapour through outlet (6),
c) at Third condenser: Condensates oils (particularly hydrocarbons comprising mixture of maximum between C5 and C10) at outlet (21) and pass the uncondensed vapour through conduit (20).

In an embodiment of method of operating a sequential condensation system, the condensation temperature for each of the condenser is set as follows:
First Condenser (16): Temperature between 300 to 400° C., More specifically about 380° C.,
Middle Condenser(s) (3): Temperature below 250° C.,
Last condenser (19): Temperature between 20 to 40° C., preferably at Room temperature.

Accordingly, the present invention provides a system and method, having a Benzoic-acid-separation step at middle condenser (3), wherein benzoic acid is inline separated from thermally decomposed gaseous matters by contacting the oil immiscible solvent at temperature about 80 to 95° C. and thereby absorbing the vapour of Benzoic-acid in said solvent and diverting optionally to agitator (not shown in figure), followed by in decanters/phase separator (7, 7′). Each Decanter will separate the oil (hydrocarbons) and Benzoic-acid solution. Further, Benzoic-acid is precipitated out by chilling the solution using heat exchanger (15) and filtering the pure precipitate to get crystals of Benzoic-acid in separator (7). Filtrate, thus can be recirculate back to middle condenser for reusing using pump (14) and heat exchanger (15).

Hence, to solve the above mentioned problem, the inventor of the present invention developed an improved sequential condensation system for clog free pyrolysis of PET containing mixed plastic waste. Wherein, the type and number of condensers employed in accordance with this invention can vary over a single condenser if it is direct contact condenser like Spray/jet condenser and two condensers if it is indirect contact condenser (Shell and tube condenser), depending on the efficiency of the particular condenser employed and the particular feedstock used.

Hence, an in-line separation of Benzoic-acid is adapted using a middle condenser to restrict the deposition of sticky mass in the internal wall of vapour stream. In accordance to one of embodiment of the present invention a direct contact of oil-immiscible solvent in condenser is bringing the communication with vapour stream coming from first condenser or directly from pyrolysis reactor and taking away the traces of Benzoic-acid and some of the condensable hydrocarbons to separating step followed by precipitation of pure Benzoic-acid and collecting clear oil-immiscible solvent at the end.

The oil immiscible solvent collected as filtrate can thus be recirculated back into a middle condenser and reused.

Additionally, the uncondensed vapor leaving the middle condenser further condensed at lower temperature in third condenser (19) to form condensate of oils and leaving non-condensable gases to vent (20) or for recirculation within the system. Further, plurality of conduits to circulate hot gases, liquid attached with two way and three way valves, heat exchangers and recirculation conduits for temperature control which forms a part hereof and which are shown by way of illustration of embodiments and not limited to the description set forth.

The improved clog free pyrolysis, in accordance with the present invention employs PET mixed feedstock including mixture of but not limited to polyethylene (PE), polypropylene (PP), polystyrene (PS), polyurethane (PU), and polyvinyl chloride (PVC) etc. which are thermally degraded to form value added products such as one or more waxes, hydrocarbon oil, pure Benzoic-acid and gases.

In the construction shown in the drawings, a middle condenser best described as a direct condenser is provided to dissolve a Benzoic-acid and some of the hydrocarbons in oil immiscible solvent used in the direct condenser, and is effectively and selectively separating away the Benzoic-acid from remaining vapor to allow in-line separation step for Benzoic-acid and preventing deposition of the same and thereby preventing clogging of the pyrolysis system.

### Example 1: Effect on Pressure Developed on Condenser with and without Process Developed as Per Present Invention and Recovery of Benzoic-Acid and its Derivatives

TABLE NO. 1

| Trials: System | | | |
|---|---|---|---|
| details used for | Condenser | Recovery of | |
| PET (100% w/w) | Pressure | Benzoic- | |
| feedstock) | Observation | acid | Remark |
| 1)Conventional | Reactor | NO | Pyrolysis |
| condensation | pressure | | reaction |
| system | reached above | | discontinued |
| [Condensing | the reactor | | after 1 Hr |
| the vapour | design | | due to |
| Between | pressure of | | clogging of |
| 200-90 deg | 0.5 kg/cm² | | condenser |
| Celsius) | | | |
| 2)Improved | Relative | Yes | Pyrolysis |
| condensation | pressure | (Including | reaction |
| system as | between | recovery of | continued |
| per present | 0.01 to 0.02 | pure value | for more |
| invention. | kg/cm² | added | than 24 Hr. |
| (FIG. 4) | | products e.g | No sticky |
| | | pyrolysis | mass in the |
| | | oils) | condenser. |

Conclusion: When this invention is not used (refer trial 1), Condenser clogging resulted in increased reactor pressure within 45 mins of starting the process. The reactor pressure was about to reach the ‘reactor design pressure of 0.5 kg/cm², this is when the pyrolysis reaction was stopped to ensure safety.

The present subject matter is described above merely with reference to the most practical preferred implementations considered at the present time. It must be understood that the explanation above is not a limitation of the present subject matter, and the present subject matter is not limited to the examples given above. Changes, alterations in form, additions or substitutions made by those skilled in the art within the substantive scope of the present subject matter should also be included in the scope of protection of the present subject matter.

1. A clog-free vapor condensation system for continuous pyrolysis of a polymer comprising a fraction of polyethylene terephthalate (PET), comprising:
(a) a conduit for carrying a vapor stream received from a pyrolysis reactor; operatively connected to
(b) a condenser having a solvent inlet for an oil-immiscible solvent stream, a liquid outlet for removal of condensed pyrolysis oil and benzoic acid dissolved in the oil-immiscible solvent, and a vapor outlet for the passing of uncondensed pyrolysis vapors; and
(c) a first liquid-liquid phase separator operatively connected to the liquid outlet of the condenser, having a first outlet for removal of the condensed pyrolysis oil and a second outlet for removal of the oil-immiscible solvent;
wherein the vapor stream entering the condenser is humidified with the oil-immiscible solvent stream and condensed to obtain a liquid mixture of pyrolysis oil and oil-immiscible solvent rich in benzoic acid.

2. The clog-free condensation system as claimed in claim 1, wherein the condenser is a spray condenser.

3. The clog-free condensation system as claimed in claim 1, further comprising, in series with the condenser, one or more additional condensers.

4. The clog-free condensation system as claimed in claim 3, wherein the one or more additional condensers in series are independently selected from the group consisting of shell and tube condenser, central flow condenser, down flow condenser, inverted flow condenser, evaporative condenser, jet condenser, and direct contact condenser.

5. The clog-free condensation system as claimed in claim 1, wherein the second outlet of the first liquid-liquid phase separator is operatively connected to a precipitating bath for the precipitation of benzoic acid from the oil-immiscible solvent.

6. The clog-free condensation system as claimed in claim 5, wherein the precipitating bath is selected from the group consisting of temperature controlled baths and baths to which a solution can be supplied.

7. The clog-free condensation system as claimed in claim 5, wherein an outlet of the precipitating bath is operatively connected to a solid-liquid separator.

8. The clog-free condensation system as claimed in claim 7, wherein solid-liquid separator is selected from the group consisting of filter press, centrifuge, nutche filter, agitated nutche filter, pressure leaf filter, gravity filter and vacuum filtration system.

9. The clog-free condensation system as claimed in claim 7, wherein a filtrate outlet of the solid-liquid separator is operatively connected to the solvent inlet of the condenser through a pump and heat exchanger.

10. The clog-free condensation system as claimed in claim 1, further comprising a second liquid-liquid phase separator operatively connected in parallel to the first liquid-liquid phase separator.
